(19) United States
(12) Patent Application Publication
(10) Pub. No.: US 2025/0070197 A1
(43) Pub. Date: Feb. 27, 2025

(54) Droplet Removing Apparatus

(71) Applicants: Hyundal Motor Company, Seoul (KR); Kia Corporation, Seoul (KR); MANN+HUMMEL GmbH, Ludwigsburg (DE)

(72) Inventors: Min Jae Kim, Hwaseong-si (KR); Dal Jin Oh, Ansan-si (KR); Yi Jeong Jung, Wonju-Si (KR)

(21) Appl. No.: 18/630,338

(22) Filed: Apr. 9, 2024

(30) Foreign Application Priority Data
Aug. 21, 2023 (KR) 10-2023-0109243

(51) Int. Cl. H01M 8/04119

(52) U.S. Cl. CPC H01M 8/04156; H01M 8/04126

(57) ABSTRACT

A droplet removing apparatus includes a body part, a first separation part disposed in the body part and that primarily separates moisture in a fluid introduced thereinto along a first direction, and a second separation part located in the first direction of the first separation part, and that secondarily separates the moisture in the fluid, which has not been separated by the first separation part.

### CROSS-REFERENCE TO RELATED APPLICATION

This application claims the benefit of priority to Korean Patent Application No. 10-2023-0109243, filed in the Korean Intellectual Property Office on Aug. 21, 2023, the entire contents of which are incorporated herein by reference.

### TECHNICAL FIELD

The present disclosure relates a droplet removing apparatus.

### BACKGROUND

A fuel cell is a device that converts chemical energy stored in a hydrogen fuel to electrical energy through an electrochemical reaction with air. In detail, hydrogen ions provided in an anode of a fuel cell stack flow to a cathode via an electrolyte, and generate electricity while reacting with oxygen in the cathode and generating water.

The generated water has to be discharged out of the fuel cell. The generated water may be discharged through an exhaust/discharge hole. However, when the generated water is discharged through the exhaust/discharge hole, droplets may spatter (e.g., to a rear vehicle, etc.) which may damage and/or decrease a value of the vehicle. Accordingly, it is preferable that air discharged through the exhaust/discharge hole not contain droplets.

An expander for recovering energy may be mounted on the fuel cell. In this case, when the air introduced into the expander contains droplets, a fuel ratio of the expander is reduced.

In particular, when the vehicle employing the fuel cell is on or off, the water kept in a humidifier is discharged at once to an outside in a time period of around 10 to 30 seconds. In this case, sizes of the discharged droplets become larger as compared with a general driving state (e.g., the general drivng state of the vehicle after the vehicle is turned on and before the vehicle is turned off).

### SUMMARY

The following summary presents a simplified summary of certain features. The summary is not an extensive overview and is not intended to identify key or critical elements.

Systems, apparatuses, and methods are described for droplet (e.g., moisture) removal. An apparatus (e.g., a droplet/moisture removing apparatus) may comprise a body; a first separator disposed in the body and configured to separate a first portion of moisture in a fluid introduced to the first separator along a first direction; and a second separator disposed in the body in the first direction of the first separator, and configured to secondarily separate a second portion of the moisture, in the fluid, that has not been separated by the first separator. The body may comprise: an introduction passage configured to guide the introduced fluid along the first direction; a first body member connected to the introduction passage in the first direction such that an interior of the first body member is contiguous with an interior of the introduction passage, wherein the first body member has a diameter that is larger than a diameter of the introduction passage; a second body member connected to the first body member in the first direction and comprising a discharge opening that opens parallel to the first direction, wherein the discharge opening has a diameter that is smaller than a diameter of the introduction passage; and a moisture discharge passage connected to a side of the first body member in a second direction that is perpendicular to the first direction, and configured to discharge the first portion of the moisture and the second portion of the moisture.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a droplet removing apparatus according to an example of the present disclosure;

FIG. 2 is a view illustrating an internal structure of the droplet removing apparatus of FIG. 1;

FIG. 3 is an exploded perspective view of the droplet removing apparatus of FIG. 1;

FIG. 4 is a view conceptually illustrating a first separation part;

FIG. 5 is an exploded perspective view of a second separation part;

FIG. 6 is an exploded perspective view of a heating part;

FIG. 7 is a view conceptually illustrating flows of a fluid in a general driving situation; and

FIG. 8 is a view conceptually illustrating flows of a fluid in a situation, in which a start is on or off.

### DETAILED DESCRIPTION

Hereinafter, examples of the present disclosure will be described in detail with reference to the accompanying drawings. In adding reference numerals to the components of the drawings, it is noted that the same components are denoted by the same reference numerals even if they are drawn in different drawings. Furthermore, in describing the examples of the present disclosure, if it is determined that a detailed description of related known configurations and/or functions may hinder understanding of the examples of the present disclosure, a detailed description thereof will be omitted.

A droplet removing apparatus (e.g., a moisture removing apparatus/device, a moisture remover, a gas/liquid separator) that may be mounted to a fuel cell part of a vehicle and that may have a high separation efficiency to remove large droplets is disclosed herein.

A droplet removing apparatus according to an example of the present disclosure may be a droplet removing apparatus that for a fuel cell system. The droplet removing apparatus may function to remove moisture from a gas that is discharged from a humidifier of a fuel cell system (e.g., discharged toward an exhaust hole).

As an example, the droplet removing apparatus may be disposed downstream of a pressure control valve that is connected to the humidifier of the fuel cell system. The droplet removing apparatus may be disposed on an upstream side of an expander of the fuel cell system.

An “upstream side” and a “downstream side”, as used in the present disclosure, may refer to a flow direction of a fluid. For example, when the fluid flows from a left side to a right side, the left side may correspond to the upstream side and the right side may correspond to the downstream side. In the present disclosure, the fluid may refer to air that contains moisture.

The droplet removing apparatus, according to an example of the present disclosure, may be used for various means, such as an aircraft, an urban air mobility (UAM), a ship, and/or a hydrogen fuel cell vehicle.

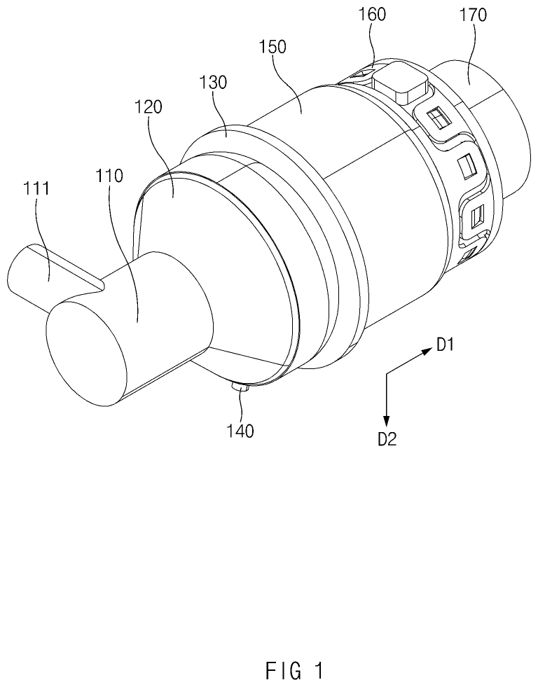

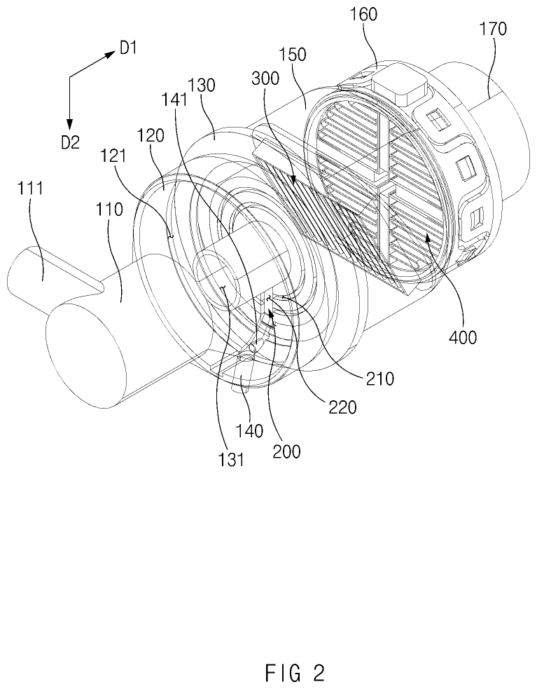

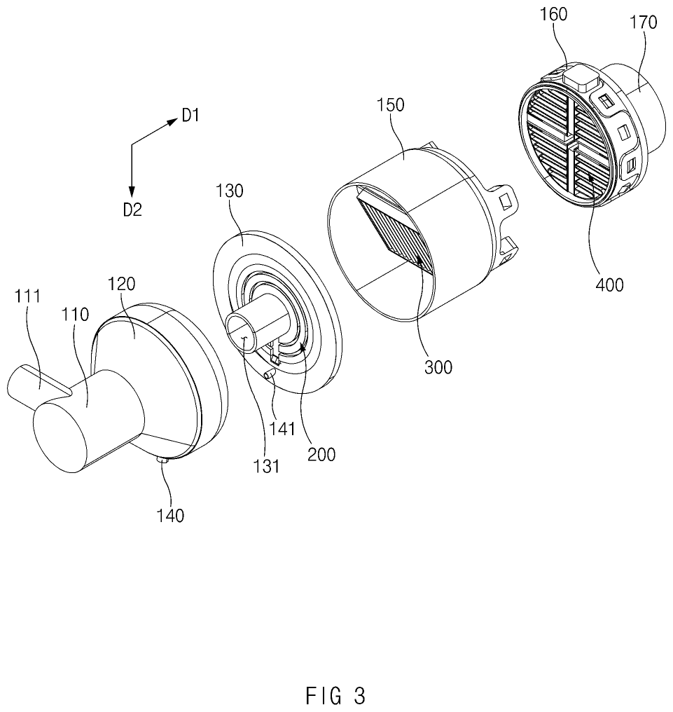

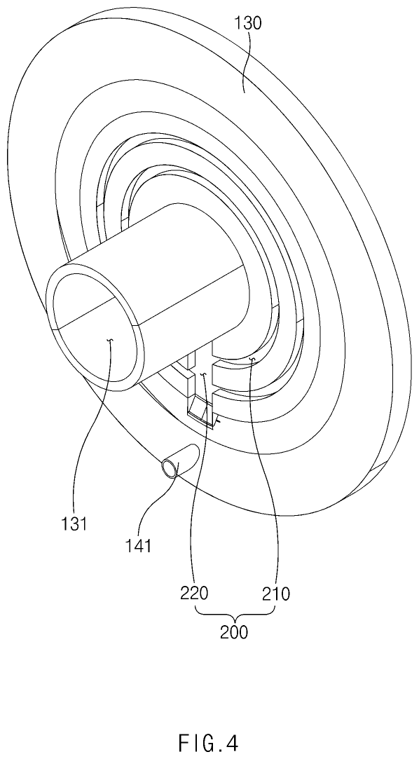

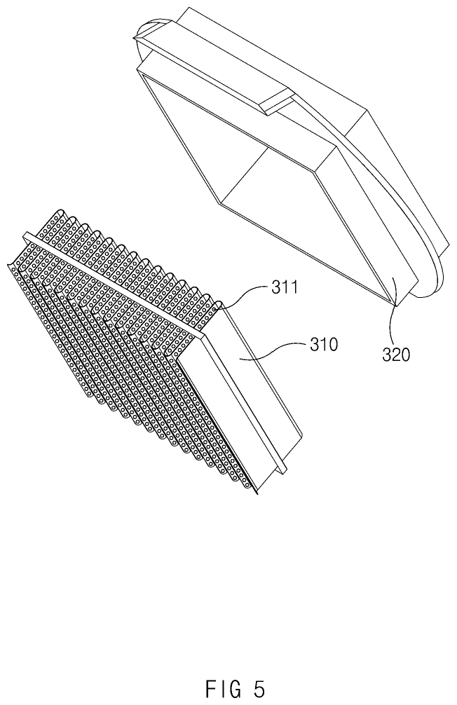

FIG. 1 is a perspective view illustrating a droplet removing apparatus according to an example of the present disclosure. FIG. 2 is a view illustrating an internal structure of the droplet removing apparatus of FIG. 1. FIG. 3 is an exploded perspective view of the droplet removing apparatus of FIG. 1. FIG. 4 is a view conceptually illustrating a first separation part. FIG. 5 is an exploded perspective view of a second separation part.

The droplet removing apparatus according to an example of the present disclosure may include a body part 100 (e.g., a body), a first separation part 200 (e.g., a first separator, a first gas/liquid separator), and a second separation part 300 (e.g., a second separator, a second gas/liquid separator). The first separation part 200 may be disposed in the body part 100, and/or may be configured to primarily separate moisture in fluid that is introduced thereinto along a first direction D1. The second separation part 300 may be located in the first direction D1 of the first separation part 200, and/or may be configured to secondarily separate the moisture in the fluid that has not been separated by the first separation part 200.

As an example, the first separation part 200 may primarily separate the moisture in the fluid by using a condensation groove structure. The second separation part 300 may secondarily separate the moisture in the fluid through a separator structure. However, the aspect that the first separation part 200 primarily separates the moisture in the fluid through the separator structure and the second separation part 300 secondarily separates the moisture in the fluid by using a centrifugal force also may be regarded as being in a range, in which an ordinary person in the art may easily change the present disclosure.

### Body Part 100

The body part 100 may include an introduction passage 110, a first body member 120 (e.g., a first body), a second body member 130 (e.g., a second body), and a moisture discharge passage 140. The introduction passage 110 may guide the introduced fluid along the first direction D1. Hereinafter, an introduction direction of the fluid is defined as the first direction D1, and a second direction D2 is defined as a direction that is perpendicular (and/or at least not parallel) to the first direction D1.

As an example, the introduction passage 110 may have a shape, of which an end in the opposite direction to the first direction DI is closed. Then, the body part 100 may further include an eccentric introduction passage 111. The eccentric introduction passage 111 may extend from a side of the introduction passage 110 in the first direction D1, in a direction that crosses the first direction D1. That is, a shape obtained by adding the introduction passage 110 and the eccentric introduction passage 111 may be a shape that is similar to an “L” shape.

A diameter (e.g., a diameter of a circular cross-section in the D1 direction, an average/maximum/minimum width of a non-circular cross-section in the D1 direction) of the eccentric introduction passage 111 may be smaller than a diameter of the introduction passage 110. The eccentric introduction passage 111 may be connected to a location that is biased to an upper side or a lower side of the introduction passage 110. As the eccentric introduction passage 111 is connected to the location that is biased to the upper side or the lower side of the introduction passage 110, the fluid introduced through the eccentric introduction passage 111 flows while having a locus of a circle, a center of which is the first direction D1 when it is introduced into the introduction passage 110. At the same time, the fluid receives a force, by which it tends to move along the first direction D1. Accordingly, the fluid may flow while drawing a spiral locus that extends along the first direction D1. Due to the flow, the moisture in the fluid receives a force, by which it tends to flow to a radially outward side (e.g., by a centrifugal force).

The first body member 120 may be connected to a side of the introduction passage 110 such that an interior thereof is communicated. A diameter of the first body member 120 may be larger than that of the introduction passage 110. As an example, the first body member 120 may have a shape, a diameter of which becomes larger along the first direction D1. An area of the first body member 120, which has the largest diameter, may be 200 mm or less.

The second body member 130 may include a discharge opening 131. The discharge opening 131 may be opened along the first direction D1, and may have a diameter that is smaller than a diameter of the introduction passage 110. The second body member 130 may be connected to a side of the first body member 120 in the first direction D1.

The moisture discharge passage 140 may be connected to a side of the first body member 120 in the second direction D2, and may be configured to discharge the moisture that is separated from the fluid. A direction, in which the moisture discharge passage 140 extends, may be a direction that is inclined in the second direction D2 with respect to the opposite direction to the first direction D1. As the moisture discharge passage 140 has an inclined shape, the moisture may be naturally discharged in a gravitational direction when the moisture discharge passage 140 is vertically and/or horizontally mounted/oriented. Here, the vertical mounting may mean a situation, in which the first direction D1 is an upward direction. The horizontal direction may mean a situation, in which the second direction D2 is a downward direction.

An area, of the body part 100, adjacent to the moisture discharge passage 140 may be inclined toward the moisture discharge passage 140. That is, the body part 100 may have a gradient toward the moisture discharge passage 140 to guide the moisture to the moisture discharge passage 140.

The body part 100 may have a moisture guide passage 141. The moisture guide passage 141 may have a shape that passes through the second body member 130. The moisture guide passage 141 may have a structure that guides the moisture generated on a side of the second body member 130 in the first direction D1 to the moisture discharge passage 140. As an example, the moisture guide passage 141 may have a specific inclination toward the moisture discharge passage 140.

The body part 100 may further include a third body member 150 (e.g., a third body). The third body member 150 may be connected to a side of the second body member 130 in the first direction D1, and an interior thereof may be communicated with the discharge opening 131. The second separation part 300 may be disposed in an interior of the third body member 150.

The body part 100 may further include a fourth body member 160 (e.g., a fourth body). The fourth body member 160 may be connected to a side of the third body member 150 in the first direction D1.

The body part 100 may further include an air discharge passage 170. The air discharge passage 170 may be connected to a side of the fourth body member 160 in the first direction D1. The air discharge passage 170 may have a diameter that is smaller than a diameter of the fourth body member 160. The air discharge passage 170 may be a passage, through which the fluid that passed through the first separation part 200, the second separation part 300, and a heating part 400 (e.g., a heater), which will be described below, is discharged.

### First Separation Part 200

The first separation part 200 may be disposed in the introduction passage 110. The first separation part 200 may separate the moisture through a centrifugal force in the introduction passage 110.

As an example, the first separation part 200 may be formed in the second body member 130. As an example, the first separation part 200 may include a condensation groove 210. The condensation groove 210 may be formed on a side surface of the second body member 130 in the opposite direction to the first direction D1, and may be opened along the opposite direction to the first direction D1.

A plurality of condensation grooves 210 may be formed. As an example, the plurality of condensation grooves 210 may have concentric shapes having different diameters. As the condensation grooves 210 have the circular shapes (e.g., substantially circular and/or arced shapes), the moisture in the fluid circulates along a circle (e.g., and/or arcs), and in this process, condensation by a centripetal force may be performed more smoothly. As another example, the condensation grooves may be formed to form a plurality of spirals.

The moisture introduced into the introduction passage 110 may be rotated due to being introduced via the eccentric introduction passage 111, and may collide with a surface of the second body member 130 facing the opposite direction to the first direction D1. The condensation grooves 210 may be spaces, in which the moisture that collides with the surface of the second body member 130 in the opposite direction to the first direction D1 may be condensed and/or may flow. The moisture may be condensed and/or may be guided to the moisture discharge passage 140 (e.g., in a form of droplets).

The first separation part 200 may further include a guide groove 220. The guide groove 220 may be formed to be communicated with ends of the plurality of condensation grooves 210 in the second direction D2, may extend toward the second direction D2, and may be configured to guide the moisture in the condensation grooves 210 to the moisture discharge passage 140.

### Second Separation Part 300

The second separation part 300 may include a plurality of separation holes 311. The separation holes 311 may be configured such that droplets are formed. For example, the second separation part 300 may have a mesh structure and/or comprise a mesh. The second separation part 300 may easily separate droplets of relatively larger sizes as compared with the first separation part 200 that uses a centripetal force.

As an example, the second separation part 300 may include a second separation member 310 having the separation holes 311, and/or a fixing member 320 that is configured to fix the second separation member 310.

The second separation part 300 may be disposed such that a direction which the second separation part 300 faces crosses the first direction D1 (e.g., the direction which the separation part 300 faces is not parallel or antiparallel to the first direction D1). As an example, the second separation part 300 may be disposed such that an end of the second separation part 300 in an opposite direction to the second direction D2 is closer to the second body member 130 than an end of the second separation part 300 in the second direction D2. This may mean that the second separation member 310 is disposed to be inclined relative to the first direction D1 as described above due to the shape of the fixing member 320.

According to the present disclosure, as the second separation part 300 is disposed to be inclined, the droplets formed in the second separation member 310 may naturally drop along the second direction D2. The dropping droplets may be guided to the moisture discharge passage 140. As an example, the dropping droplets may be guided to the moisture discharge passage 140, for example, along a through passage 180 that passes through the second body member 130.

Accordingly, a probability of the droplets passing through the second separation part 300 may become lower than in a case in which the second separation part 300 is disposed to be perpendicular to the first direction D1.

The second separation member 310 may have a shape that is folded in zigzags. Through the shape, a surface area of the second separation member 310 per volume thereof may increase, and thus, the flows of the droplets may be effectively hindered.

The fixing member 320 may have a bypass passage for preventing the flows of the fluid from being hindered. As an example, the bypass passage may have a shape of a hole. This is a structure for preventing a passage blocking phenomenon that may occur when droplets are introduced in an amount of greater than a maximum limit of droplets that the second separation member 310 is able to separate.

### Heating Part 400

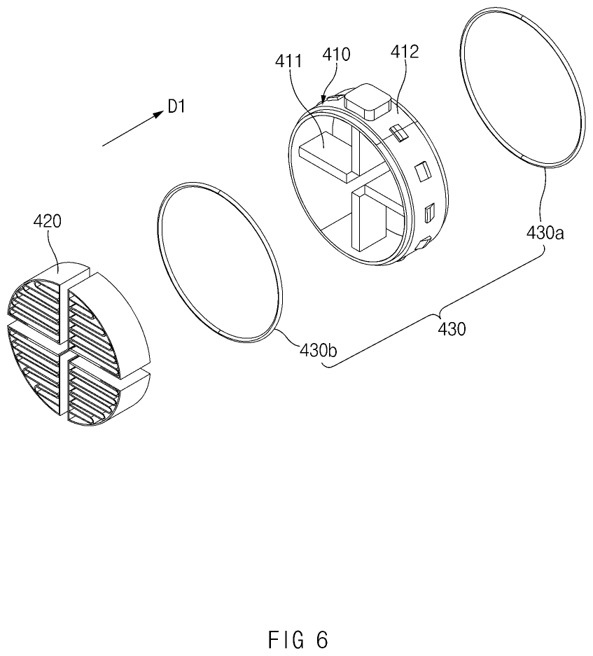

FIG. 6 is an exploded perspective view of the heating part 400. The droplet removing apparatus according to an example of the present disclosure may further include the heating part 400. The heating part 400 may be disposed in an interior of the fourth body member 160 to heat the fluid. The heating part 400 may heat the fluid that passed through the second separation part 300, and may prevent the residual moisture in the fluid from being condensed.

As an example, the heating part 400 may include a heater 410 and a heat sink 420. The heater 410 may have a cross area 411 having a cross shape and a peripheral area 412 that surrounds the cross structure when viewed along the first direction D1. The cross area 411 may be an area that may be heated to transfer heat to the heat sink 420. The peripheral area 412 may be an area that hinders transfer of heat that is radiated from the cross area 411.

The heat sink 420 may be disposed between the cross area 411 and the peripheral area 412. The heat sink 420 may receive the heat from the cross area 411 and may heat the fluid that passes through the heat sink 420.

The heating part 400 may further include an electric power connection part. The electric power connection part may be a part that is exposed to an outside of the body part 100 to be electrically connected to an external power source.

The heating part 400 may further include a sealing member 430. The sealing member 430 may seal an aperture between the heating part 400 and the body part 100. As an example, the sealing member 430 may include a first sealing member 430a and a second sealing member 430b. The first sealing member 430a may be disposed in the first direction DI of the peripheral area 412, and the second sealing member 430b may be disposed on an opposite direction thereto.

The first body member 120 may include a guide groove 121. The guide groove 121 may be recessed from an inner surface of the first body member 120 to guide the moisture that is separated from the fluid. Also, or alternatively, a guide boss may protrude from the inner surface of the first body member 120 to guide the moisture separated from the fluid. As an example, the guide groove 121 may be formed in a circular shape to guide the moisture that is separated from the fluid.

### Operation of Present Disclosure

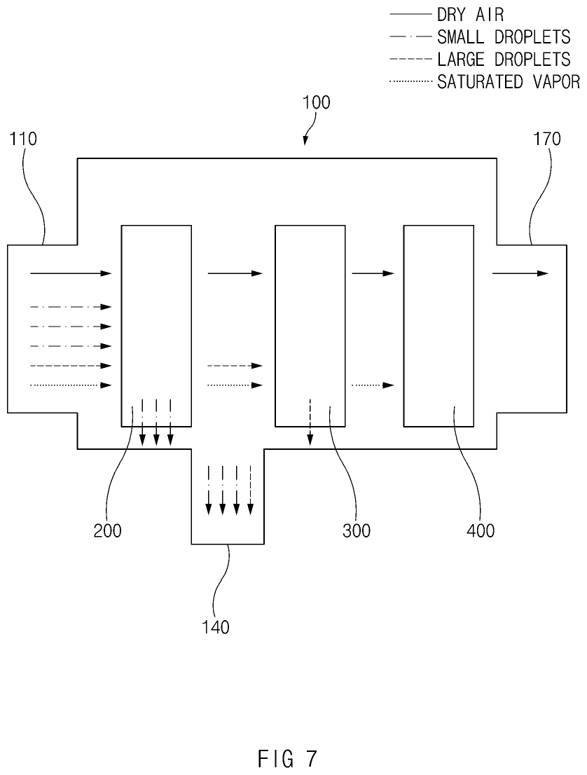

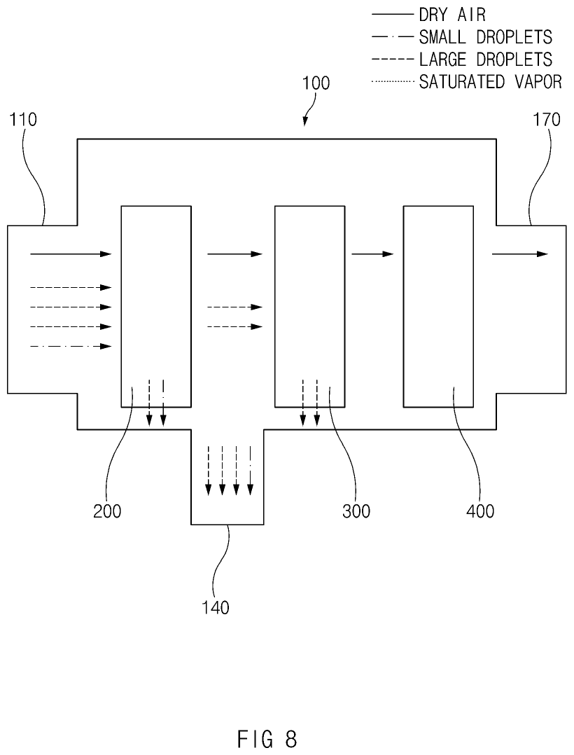

Hereinafter, an operation of the present disclosure will be described in detail with reference to FIGS. 7 and 8. First, a case of a general driving situation will be described in detail, and a case of a situation, in which a start is on or off, will be described in detail next. FIG. 7 is a view conceptually illustrating flows of a fluid in a general driving situation. FIG. 8 is a view conceptually illustrating flows of the fluid in a situation, in which the start is on or off.

In the general driving situation (e.g., while the vehicle is moving), the fluid may contain dry air, small droplets, large droplets, and saturated vapor. The fluid that is introduced through the introduction passage 110 passes through the first separation part 200. Mainly small droplets may be removed from the fluid by passing through the first separation part 200. The small droplets separated via the first separation part 200 may be discharged to the moisture discharge passage 140.

The fluid that passed through the first separation part 200 may pass through the second separation part 300. In this process, the large droplets may be removed. The large droplets separated from the fluid via the second separation part 300 may be discharged through the moisture discharge passage 140.

The fluid that passed through the second separation part 300 may pass through the heating part 400. The saturated vapor may be heated by the heating part 400 and thus, the condensation thereof may be hindered. Accordingly, the fluid that passed through the heating part 400 may be finally discharged in a state, in which a ratio of dry air and saturated vapor are high.

In a situation, in which the start is on or off, the moisture that is kept for a time period of about 10 seconds to 30 seconds may be discharged to an outside. In this case, few saturated vapor is present in the fluid, and the large droplets occupies most of them.

Like in the general driving situation, the fluid introduced through the introduction passage 110 passes through the first separation part 200, which may primarily remove small droplets. As such, the fluid that passed through the first separation part 200 may be in a state, in which the small droplets are mainly removed.

The fluid that passed through the first separation part 200 may pass through the second separation part 300. In the situation, in which the start is on or off, the ratio of the large droplets is very high, but the second separation part 300 physically hinders the flows of the fluid through the mesh structure, and thus, the large droplets may be smoothly separated (e.g., as compared with a case using the centrifugal force alone).

Accordingly, the fluid that passed through the second separation part 300 may be discharged in a state, in which the ratio of the dry air to saturated air is high.

The present disclosure has been made to solve the above-mentioned problems occurring in the prior art while advantages achieved by the prior art are maintained intact.

An aspect of the present disclosure provides a droplet removing apparatus having an improved droplet removal efficiency.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a droplet removing apparatus includes a body part, a first separation part disposed in the body part and that primarily separates moisture in a fluid introduced thereinto along a first direction, and a second separation part located in the first direction of the first separation part, and that secondarily separates the moisture in the fluid, which has not been separated by the first separation part, and the body part includes an introduction passage that guides the introduced fluid along the first direction, a first body member connected to a side of the introduction passage in the first direction such that an interior thereof is communicated, and having a diameter that is larger than that of the introduction passage, a second body member including a discharge opening opened along the first direction and having a diameter that is smaller than a diameter of the introduction passage, and connected to a side of the first body member in the first direction, and a moisture discharge passage connected to a side of the first body member in a second direction that is one direction that is perpendicular to the first direction, and that discharges the moisture separated from the fluid.

The first separation part may be formed in the second body member.

The first separation part may include a condensate groove formed on a side surface of the second body member in an opposite direction to the first direction, and opened along the opposite direction to the first direction.

A plurality of condensation grooves may be formed, and the plurality of condensate grooves may have concentric shapes having different diameters.

The first separation part may further include a guide groove formed to be communicate with ends of the plurality of condensate grooves in the second direction, extending toward the second direction, and that guides the moisture of the condensate groove to the moisture discharge passage.

The body part may further include a third body member connected to a side of the second body member in the first direction, and an interior of which is communicated with the discharge opening, and the second separation part may be disposed in an interior of the third body member.

The second separation part may include a plurality of separation holes, in which droplets are formed.

The second separation part may be disposed such that a direction which the second separation part faces crosses the first direction.

The second separation part may be configured such that an end of the second separation part in an opposite direction to the second direction is disposed to be closer to the second body member than an end of the second separation part in the second direction.

The body part may further include a fourth body member connected to a side of the third body member in the first direction, and the droplet removing apparatus may further include a heating part disposed in an interior of the fourth body member and that heats the fluid.

The body part may further include an air discharge passage connected to a side of the fourth body member in the first direction, and having a diameter that is smaller than a diameter of the fourth body member.

The first body member may include a first body area, a diameter of which becomes larger along the first direction, and a guide boss protruding from an inner surface of the first body area, and that guides the moisture separated from the fluid.

A direction, in which the moisture discharge passage extends, may be a direction that is inclined in the second direction with respect to an opposite direction to the first direction.

An end of the introduction passage of the body part in an opposite direction to the first direction may have a closed shape, and the droplet removing apparatus may further include an eccentric introduction passage extending from a side of the introduction passage in the opposite direction to the first direction in a direction crossing the first direction.

A diameter of the eccentric introduction passage may be formed to be smaller than the diameter of the introduction passage, and the eccentric introduction passage may be connected to a location that is biased to an upper side or a lower side of the introduction passage.

According to the present disclosure, all of separation of droplets using a centrifugal force, separation of droplets through a separator, and separation of droplets through heating may be performed, and thus, a droplet separation efficiency may be enhanced.

The above description is simply an exemplary description of the technical spirits of the present disclosure, and an ordinary person in the art, to which the present disclosure pertains, may make various corrections and modifications without departing from the essential characteristics of the present disclosure. Therefore, the examples disclosed in the present disclosure are not for limiting the technical spirits of the present disclosure but for describing them, and the scope of the technical spirits of the present disclosure is not limited by the examples. The protection scope of the present disclosure should be construed by the following claims, and all the technical spirits in the equivalent range should be construed as being included in the scope of the present disclosure.

What is claimed is:

1. An apparatus comprising:
a body;
a first separator disposed in the body and configured to separate a first portion of moisture in a fluid introduced to the first separator along a first direction; and
a second separator disposed in the body in the first direction of the first separator, and configured to secondarily separate a second portion of the moisture, in the fluid, that has not been separated by the first separator,
wherein the body comprises:
an introduction passage configured to guide the introduced fluid along the first direction;
a first body member connected to the introduction passage in the first direction such that an interior of the first body member is contiguous with an interior of the introduction passage, wherein the first body member has a diameter that is larger than a diameter of the introduction passage;
a second body member connected to the first body member in the first direction and comprising a discharge opening that opens parallel to the first direction, wherein the discharge opening has a diameter that is smaller than a diameter of the introduction passage; and
a moisture discharge passage connected to a side of the first body member in a second direction that is perpendicular to the first direction, and configured to discharge the first portion of the moisture and the second portion of the moisture.

2. The apparatus of claim 1, wherein the first separator is in the second body member.

3. The apparatus of claim 2, wherein the first separator comprises:
a surface of the second body member facing an opposite direction to the first direction, wherein the surface of the second body member forms at least one condensate groove that is open toward the opposite direction to the first direction.

4. The apparatus of claim 3, wherein the at least one condensate groove comprises a plurality of condensate grooves, and
wherein the plurality of condensate grooves have concentric shapes having different diameters.

5. The apparatus of claim 4, wherein
a guide groove, formed in the surface of the second body member, is in communication with ends of the plurality of condensate grooves, extends toward the second direction, and is configured to guide the moisture of the plurality of condensate grooves to the moisture discharge passage.

6. The apparatus of claim 1, wherein the body further comprises:
a third body member connected to the second body member in the first direction, wherein an interior of the third body member is communication with the discharge opening,
wherein the second separator is disposed in an interior of the third body member.

7. The apparatus of claim 6, wherein the second separator comprises a plurality of separation holes configured to allow droplets to form from the second portion of the moisture in the fluid.

8. The apparatus of claim 7, wherein the second separator is disposed to face in a direction that crosses the first direction.

9. The apparatus of claim 8, wherein the second separator is configured such that an end of the second separator in an opposite direction to the second direction is disposed to be closer to the second body member than an end of the second separator in the second direction.

10. The apparatus of claim 6, wherein the body further comprises:
a fourth body member connected to a side of the third body member in the first direction, and
wherein the apparatus further comprises a heater disposed in an interior of the fourth body member and configured to heat the fluid.

11. The apparatus of claim 10, wherein the body further comprises:
an air discharge passage connected to a side of the fourth body member in the first direction, and having a diameter that is smaller than a diameter of the fourth body member.

12. The apparatus of claim 1, wherein the first body member comprises:
a first body area having a diameter that increases along the first direction; and
a guide formed on an inner surface of the first body area and configured to guide the first portion of the moisture toward the moisture discharge passage.

13. The apparatus of claim 1, wherein a direction, in which the moisture discharge passage extends, is a direction that is inclined towards the second direction with respect to an opposite direction of the first direction.

14. The apparatus of claim 1, wherein an end of the introduction passage in an opposite direction to the first direction is closed, and
wherein the apparatus further comprises an eccentric introduction passage extending from a side of the introduction passage and in a direction crossing the first direction.

15. The apparatus of claim 14, wherein a diameter of the eccentric introduction passage is smaller than the diameter of the introduction passage, and
wherein the eccentric introduction passage is connected to a side of the introduction passage at a location and orientation configured to direct the fluid into the introduction passage away from a central axis of the introduction passage.
